(19) United States
(12) Patent Application Publication
(10) Pub. No.: US 2010/0293691 A1
(43) Pub. Date: Nov. 25, 2010

(54) MULTILAYERED MATERIAL SHEET FOR USE IN SOFT BALLISTICS

(76) Inventors: Shitij Chabba, Charlotte, NC (US); David Vanek, Charlotte, NC (US); David Cordova, Laytonsville, MD (US)

Correspondence Address: NIXON & VANDERHYE, PC, 901 NORTH GLEBE ROAD, 11TH FLOOR, ARLINGTON, VA, 22203, US

(21) Appl. No.: 12/663,125

(22) PCT Filed: Jun. 5, 2008
(86) PCT No.: PCT/EP2008/004486

§ 371 Date: Jun. 1, 2010

Related U.S. Application Data
(60) Provisional application No. 60/924,980, filed on Jun. 7, 2007.

(30) Foreign Application Priority Data
Jun. 6, 2007 (EP) 07011129.9

(51) Int. Cl. F41H 1/02; B32B 5/24; B32B 5/26; F41H 5/04

(52) U.S. Cl. 2/2.5; 442/370; 442/225; 89/36.05; 89/36.02; 89/914

(57) ABSTRACT

The invention relates to a multilayered material sheet comprising a stack of fibrous layers and one or more substacks of trauma reducing layers, wherein at least one of the substacks is positioned within the stack. The invention further relates to the use of the material sheet in the manufacture of soft antiballistic articles.

The invention relates to a multilayered material sheet comprising a non-consolidated stack of fibrous layers and one or more trauma reducing layers.

Such multilayered material sheets are used in soft antiballistic articles, such as bullet resistant vests and soft armor systems. An important requirement for such articles is obviously to be able to stop projectiles impacting the article. In addition however, it is also important to be able to limit deformations in the article, and in particular trauma or Back Face Deformation (BFD). A soft armor system for instance may stop an impacting projectile from completely penetrating the system but may deform so badly on its non-impact side that damage occurs to the equipment or person being protected by the armor system. Solutions to limit BFD in soft antiballistic articles have been proposed in the art. These solutions generally propose to add trauma reducing layers to the back face, i.e. the side opposite to the side facing a ballistic threat—the strike face, of the multilayered material sheet.

A multilayered material sheet comprising a stack of fibrous layers and several trauma reducing layers is known from US 2003/0200861A1. This publication discloses a body armor system comprising an assembly of at least two substacks, each containing a plurality of fibrous layers. According to US 2003/0200861A1, the first substack comprises a plurality of fibrous layers arranged to receive an impact from a projectile prior to the second substack, and engages the projectile to slow its velocity. The fibrous layers in the first substack may be arranged in the form of a needle punched felt. The second substack dissipates the incoming energy of the impact to resist complete penetration of the second substack by the projectile. The fibrous layers in the second substack may be in the form of a woven fabric of anti-ballistic fibers. The substacks in the disclosed multilayered material sheet are always arranged such that the first substacks are positioned on the outside of the stack. According to the teaching of US 2003/0200861A1 therefore, the fibrous layers acting to slow down the projectiles velocity should be on the back face of the multilayered material sheet. By slowing down the projectiles velocity upon impact, trauma is apparently reduced.

Although the multilayered material sheet according to US 2003/0200861A1 shows a satisfactory antiballistic performance, this performance can be improved further.

The object of the present invention is to provide a multilayered material sheet having improved antiballistic properties in the form of reduced trauma or Back Face Deformation when compared to the known material.

This object is achieved according to the invention by providing a soft ballistic resistance article comprising a stack of fibrous layers and one or more substacks of trauma reducing layers, wherein at least one of the substacks is positioned within the stack. It has surprisingly been found that this particular combination of features yields an improved antiballistic performance in the form of reduced trauma or Back Face Deformation over the known multilayered material sheet. More in particular, the average BFD of the multilayered material sheet is surprisingly less than the BFD of the known multilayered material sheet for a similar weight. This is particularly useful for applications where a low weight is important, such as for vests. Low weight provides maximum comfort to the wearer of the vest. Since the material sheet according to the invention provides an improved safety margin over the known sheet, it can be construed with less fibrous layers, and therefore lighter.

A particularly preferred multilayered material sheet according to the invention is characterized in that the stack comprises at least two substacks of trauma reducing layers, separated by at least one fibrous layer. Such a preferred embodiment shows a further improved antiballistic performance. By having at least two substacks of trauma reducing layers within the stack of fibrous layers, a projectile, when travelling through the stack, is apparently slowed down consecutively thus reducing the BFD. An even more preferred embodiment of the material sheet of the invention is characterized in that the stack comprises at least three substacks, more preferably at least four substacks, separated by at least one fibrous layer. More preferably at least one fibrous layer is present between each set of 2 adjacent positioned substacks. Even more preferably the distance or the number of fibrous layers, between 2 adjacent substacks is not constant. This means that the number of fibrous layers between a first and a second substack is different from the fibrous layers between e.g. said second and a third substack. Even more preferably the multilayered material sheet comprises at least one substack of trauma reducing layers that is faced with fibrous layers, the number of which fibrous layers differs with at least 10% with the number of fibrous layers facing another substack of trauma reducing layers. Most preferably the number of said fibrous layers differs with at least 20%. Such non uniform spacing between the trauma reducing layers further improves, i.e. reduces, the back face deformation.

It is in principle possible to vary the amount of trauma reducing layers within each substack within wide ranges. For most soft antiballistic applications the total amount of fibrous layers typically ranges from about 20 to about 60. Preferred total amounts of trauma reducing layers range from 1 to 20, more preferred from 2 to 10, and most preferred from 3 to 6. In a preferred material sheet according to the invention each substack comprises at most four trauma reducing layers, more preferred at most two trauma reducing layers, and most preferred only one trauma reducing layer. A particularly preferred embodiment has at least four substacks, whereby most or all of the substacks comprise only one trauma reducing layer. Such an embodiment, wherein the trauma reducing layers are distributed across the thickness dimension of the stack yields the lowest BFD, especially when the number of fibrous layers between different adjacent substacks is not constant.

In the known multilayered material sheet, the trauma reducing layers are positioned on the back face of the stack of fibrous layers. The preferred position is at the back face, i.e. the non-impact side of the stack. In the multilayered material sheet according to the invention, the trauma reducing layers within the stack are preferably positioned towards the front side (the strike face) of the stack, which is contrary to common belief. In a particularly preferred material sheet according to the invention, at least 50% of the total areal weight of the trauma reducing layers is positioned in the half part of the stack facing the impact side or strike face. Even more preferred, at least 75% of the total areal weight of the trauma reducing layers is positioned in the half part of the stack facing the strike face.

According to the invention, the multilayered material sheet comprises fibrous layers and trauma reducing layers. The layers may be interconnected such that the complete stack remains pliable. Suitable connection techniques include stitching, preferably along the ridges of the stack only. Furthermore stitching may be applied across the surface of a layer. Such surface stitching may be applied to a part of the layers. Preferably some of the fibrous layers are partially or completely surface stitched. Typically between 2 and 100%, preferably between 5 and 80%, more preferably between 7 and 50%, most preferably between 10 and 35% of the fibrous layers are surface stitched. Such surface stitching further reduces back face deformation.

The fibrous layers preferably comprise networks of fibers, whereas the trauma reducing layers preferably comprise networks of fibers, but may also comprise other material forms as elucidated below.

By network is meant tapes or fibers arranged in configurations of various types. For example, the plurality of fibers can be grouped together to form a twisted or untwisted yarn, for example the fibers or yarns may be formed as a felt, knitted or woven (plain, basket, satin and crow feet weaves, etc.) into a network, fabricated into a non-woven fabric (random or ordered orientation), arranged in a parallel array, layered, or formed into a fabric by any of a variety of conventional techniques.

In a preferred embodiment the fibrous layers of the stack comprise networks selected from the group consisting of a woven network of reinforcing fibers, a knitted network of reinforcing fibers, a braided network of reinforcing fibers, and a nonwoven network of oriented reinforcing fibers. More preferably the fibrous layers comprise cross plied UD. This term will be explained later.

A further preferred embodiment of the material sheet according to the invention is characterized in that the nonwoven network of oriented reinforcing fibers comprises a plurality of unidirectional monolayers, whereby adjacent monolayers are crossplied with respect to each other, also referred to as “cross plied UD”. In the context of the present invention, the term “unidirectional monolayer” refers to a layer of a fibrous network of unidirectionally oriented reinforcing fibers and, optionally, a binder that basically holds the reinforcing fibers together. The term “unidirectionally oriented reinforcing fibers” refers to reinforcing fibers in one plane that are essentially oriented in parallel. “Reinforcing fibre” here means an elongate body whose length dimension is greater than the transverse dimensions of width and thickness. The term “reinforcing fibre” includes a monofilament, a multifilament yarn, a tape, a strip, a thread, a staple fibre yarn and other elongate objects having a regular or irregular cross-section. In a further preferred embodiment of the material sheet according to the invention, the reinforcing fibers in one monolayer are oriented at an angle with respect to the reinforcing fibers in another monolayer. In a preferred material sheet the network comprises interlaced or woven unidirectional tapes.

The monolayers used in a preferred embodiment of the invention may contain a binder. It is important that the fibrous layers are mutually not substantially consolidated with the binder between networks, in order to connect the fibrous layers such that the complete stack or multilayered material sheet remains pliable.

The term binder refers to a material that binds or holds the reinforcing fibers together in the sheet comprising monolayers of unidirectionally oriented reinforcing fibers and a binder, the binder may enclose the reinforcing fibers in their entirety or in part, such that the structure of the monolayer is retained during handling and manufacturing of preformed sheets. The binder may be applied in various forms and ways; for example as a film (by melting hereof at least partially covering the anti ballistic fibers), as a transverse bonding strip or as transverse fibers (transverse with respect to unidirectional fibers), or by impregnating and/or embedding the fibers with a matrix material, e.g. with a polymer melt, a solution or a dispersion of a polymeric material in a liquid. Preferably, matrix material is homogeneously distributed over the entire surface of the monolayer, whereas a bonding strip or bonding fibers may be applied locally. In a preferred embodiment, the binder is a polymeric matrix material, and may be a thermosetting material or a thermoplastic material, or mixtures of the two. The elongation at break of the matrix material is preferably greater than the elongation of the fibers. The binder preferably has an elongation of 2 to 600%, more preferably an elongation of 4 to 500%. In the case the matrix material is a thermosetting polymer vinyl esters, unsaturated polyesters, epoxies or phenol resins are preferably selected as matrix material. In the case the matrix material is a thermoplastic polymer polyurethanes, polyvinyls, polyacrylics, polyolefins or thermoplastic elastomeric block copolymers such as polyisopropene-polyethylene-butylene-polystyrene or polystyrene-polyisoprene-polystyrene block copolymers are preferably selected as matrix material. Preferably the binder consists of a thermoplastic polymer, which binder preferably completely coats the individual filaments of said reinforcing fibers in a monolayer, and which binder has a tensile modulus (determined in accordance with ASTM D638, at 25° C.) of at least 250 MPa, more preferably of at least 400 MPa. Such a binder results in high flexibility of a sheet comprising a monolayer, and of a high enough stiffness in a consolidated stack.

Preferably, the amount of binder in the monolayer is at most 30 mass %, more preferably at most 25, 20, or even more preferably at most 15 mass %. This results in the best ballistic performance.

The trauma reducing layers in the multilayered material sheet according to the invention preferably comprise networks selected from the group consisting of a nonwoven network of randomly oriented reinforcing fibers, an open knitted network of reinforcing fibers, and/or a polymeric film and/or a polymeric foam. More preferably the trauma reducing layer in the multilayered material sheet according to the invention comprises a non woven network of randomly oriented reinforcing fibers, a polymeric film or a polymeric foam. In a first preferred embodiment of the material sheet according to the invention, the trauma reducing layer comprises nonwoven networks of randomly oriented reinforcing fibers, more preferably nonwoven networks of randomly oriented discontinuous reinforcing fibers, even more preferably a felt, and most preferably a needle punched felt.

Preferred nonwoven networks of randomly oriented discontinuous reinforcing fibers have fiber lengths ranging from about 0.50 to 50 cm, more preferably from about 2.50 to 25 cm, and most preferably from about 5 to 15 cm. As fiber length increases the anti-ballistic performance generally also improves. Nonwoven networks of randomly oriented discontinuous reinforcing fibers are known per se and may be prepared by carding for instance or by air or liquid laying. Consolidating or bonding the network of reinforcing fibers for handling may be carried out mechanically, for instance by needle punching, chemically, for instance with an adhesive, and/or thermally by forming point bonds or intermingling with reinforcing fibers with a lower melting point. Preferred nonwoven networks of randomly oriented discontinuous reinforcing fibers are consolidated by needle punching, alone or followed by one of the other methods.

A further preferred material sheet according to the invention is characterized in that the trauma reducing layer comprises a polymeric film and/or a polymeric foam. Suitable (thermoplastic) polymers include polyamides, polyimides, polyethersulphones, polyetheretherketone, polyurethane, polyolefines, such as polyethylene and polypropylene, polyphenylene sulphides, polyamide-imides, acrylonitrile butadiene styrene (ABS), styrene/maleic anhydride (SMA), polycarbonate, polyphenylene oxide blend (PPO), thermoplastic polyesters such as polyethylene terephthalate, polybutylene terephthalate, as well as mixtures and copolymers of one or more of the above polymers. A polymeric foam, especially a polyethylene foam is particularly preferred. Polycarbonate is a particularly preferred polymeric film. Thermosetting polymers may also be used. Suitable examples include epoxies, unsaturated polyester resins, melamine/formaldehyde resins, phenol/formaldehyde resins, polyurethane resins, and the like.

Suitable arial densities of the trauma reducing layers in the form of a polymeric film and/or foam may be selected within broad ranges. Preferred arial densities range from 10 to 500 g/m², more preferably from 50 to 400 g/m², and most preferably from 100 and 350 g/m². Preferred arial densities of the trauma reducing layers in the form of a nonwoven network of randomly oriented fibers range from 20 to 500 g/m², more preferably from 80 to 400 g/m², even more preferably from 100 to 300 g/m², and most preferably from 150 to 250 g/m². Preferred arial densities of the fibrous layers range from 50 to 500 g/m², more preferably from 80 to 250 g/m², and most preferably from 100 to 200 g/m².

Any natural or synthetic fibre may in principle be used as reinforcing fibre in the fibrous layers and/or trauma reducing layers. Use may be made of for instance metal fibres, semimetal fibres, inorganic fibres, organic fibres or mixtures thereof. The fibres should be ballistically effective, which, more specifically, requires that they have a high tensile strength, a high tensile modulus and/or high energy absorption. Such fibers are in the context of this application also referred to as anti-ballistic fibers. It is preferred for the reinforcing fibers in the monolayer of the invention to have a tensile strength of at least about 1.5 GPa, more preferred at least about 2.0 GPa, even more preferred at least about 2.5 GPa, and most preferred at least about 4 GPa. It is preferred for the reinforcing fibers in the monolayer of the invention to have a tensile modulus of at least 40 GPa. Suitable reinforcing fibers may be inorganic or organic reinforcing fibers. Suitable inorganic reinforcing fibers are, for example, glass fibers, carbon fibers and ceramic fibers. Suitable organic reinforcing fibers with such a high tensile strength are, for example, aromatic polyamide fibers (so-called aramid fibers), especially poly(p-phenylene teraphthalamide), liquid crystalline polymer and ladder-like polymer fibers such as polybenzimidazoles or polybenzoxazoles, esp. poly(1,4-phenylene-2,6-benzobisoxazole) (PBO), or poly(2,6-diimidazo[4,5-b-4′,5′-e]pyridinylene-1,4-(2,5-dihydroxy)phenylene) (PIPD; also referred to as M5) and fibers of, for example, polyolefins, polyvinyl alcohol, and polyacrylonitrile which are highly oriented, such as obtained, for example, by a gel spinning process.

Suitable polyolefins are in particular homopolymers and copolymers of ethylene and propylene, which may also contain small quantities of one or more other polymers, in particular other alkene-1-polymers.

Particularly good results are obtained if linear polyethylene (PE) is selected as the polyolefin. Linear polyethylene is herein understood to mean polyethylene with less than 1 side chain per 100 C atoms, and preferably with less than 1 side chain per 300 C atoms; a side chain or branch generally containing at least 10 C atoms. The linear polyethylene may further contain up to 5 mol % of one or more other alkenes that are copolymerisable therewith, such as propene, butene, pentene, 4-methylpentene, octene. Preferably, the linear polyethylene is of high molar mass with an intrinsic viscosity (IV, as determined on solutions in decalin at 135° C.) of at least 4 dl/g; more preferably of at least 8 dl/g. Such polyethylene is also referred to as ultra-high molar mass polyethylene. Intrinsic viscosity is a measure for molecular weight that can more easily be determined than actual molar mass parameters like Mn and Mw. There are several empirical relations between IV and Mw, but such relation is highly dependent on molecular weight distribution. Based on the equation Mw=5.37×104 [IV] 1.37 (see EP 0504954 A1) an IV of 4 or 8 dl/g would be equivalent to Mw of about 360 or 930 kg/mol, respectively.

High performance polyethylene (HPPE) fibers consisting of polyethylene filaments that have been prepared by a gel spinning process, such as described, for example, in GB 2042414 A or WO 01/73173, are preferably used as (anti ballistic) reinforcing fiber. This results in a very good anti-ballistic performance per unit of weight. A gel spinning process essentially consists of preparing a solution of a linear polyethylene with a high intrinsic viscosity, spinning the solution into filaments at a temperature above the dissolving temperature, cooling down the filaments to below the gelling temperature, such that gelling occurs, and stretching the filaments before, during or after the removal of the solvent.

In a particularly preferred embodiment, the multilayered material sheet according to the invention comprises at least 2 unidirectional monolayers as fibrous layers, preferably at least 10 unidirectional monolayers as fibrous layers, more preferably at least 20 unidirectional monolayers as fibrous layers, even more preferably at least 40 unidirectional monolayers as fibrous layers and most preferably at least 80 unidirectional monolayers as fibrous layers. Preferably the fiber direction in a monolayer differs from the fiber direction in an adjacent monolayer, i.e. a so-called cross plied UD.

The multilayer material sheet according to the invention is particularly useful in manufacturing ballistic resistant articles, such as vests or armoured plates. Most preferably the multilayered material sheet according to the invention is used in the manufacture of so-called ‘soft ballistics’, which relates to flexible articles. Ballistic applications comprise applications with ballistic threat against bullets of several kinds including against armor piercing, so-called AP, bullets improvised explosive devices and hard particles such as e.g. fragments and shrapnel.

The invention furthermore relates to a multilayered material sheet comprising a stack of fibrous layers and one or more substacks of adjacently positioned trauma reducing layers, with an excellent combination of low weight and low BFD, characterized by the product of BFD (in mm) and areal density (AD in kg/m2) is less then 240 mm.kg/m2 and preferably less then 210 when tested against a .44 Magnum JHP bullet.

The present invention will now be further elucidated by the following examples and comparative experiment, without being limited thereto.

### EXAMPLES I-VII

A total of 36 monolayer packages of Dyneema® UD SB31, a cross plied UD with ultra high molecular weight polyethylene fibers commercially available from DSM Dyneema, were stacked with 4 layers of Dyneema® FR10 felt to form a multilayered material sheet. The stacking sequence is indicated in Table 1. The multilayered material sheet was stitched around its perimeter. The areal density of a sheet of Dyneema® UD SB31 was 135 g/m², whereas the areal density of a layer of Dyneema® FR10 was 200 g/m². Arial density of the total package was between 5.5 and 5.7 kg/m² for the respective examples.

### Comparative Experiment A

A total of 36 monolayer packages of Dyneema® UD SB31, were stacked to form a complete package. The complete package was stitched around its perimeter. The areal density of a sheet of Dyneema® UD SB31 was 135 g/m².

### Example VIII

A total of 36 monolayer packages of Dyneema® UD SB31, were stacked with 4 layers of Lexan® polycarbonate film to form a complete package. The complete stack was stitched around its perimeter. The stacking sequence is indicated in Table 1. The areal density of a sheet of Dyneema® UD SB31 was 135 g/m², whereas the areal density of the Lexan® polycarbonate film was 310 g/m².

### Example IX

A total of 36 monolayer packages of Dyneema® UD SB31, were stacked with 4 layers of polyethylene foam of about 8 mm thickness to form a multilayered material sheet, which was stitched around its perimeter. The stacking sequence is indicated in Table 1. The areal density of a sheet of Dyneema® UD SB31 was 135 g/m², whereas the areal density of the polyethylene foam was 360 g/m².

### Test Procedure:

All packages were tested for Back Face Deformation (BFD) measurement at NIJ 0101.04 level IIIA using .44 Magnum JHP at 436 m/sec using an internal shooting template.

### Results:

The obtained BFD values are given in Table 1.

TABLE 1
Results of anti-ballistic tests (#U means number of
Dyneema ® UD SB31 layers, #T means number of trauma
reducing layers: from strike face to back face)

| | | Average BFD |
|---|---|---|
| | Stacking sequence | (mm) |
| Example I | 18U/1T/10U/2T/4U/1T/4U | 38 |
| Example II | 20U/2T/8U/2T/8U | 38 |
| Example III | 5U/1T/8U/1T/10U/1T/8U/1T/5U | 37 |
| Example IV | 8U/1T/10U/1T/10U/1T/4U/1T/4U | 35 |
| Example V | 8U/4T/28U | 39 |
| Example VI | 28U/4T/8U | 40 |
| Example VII | 18U/4T/18U | 39 |
| Example VIII | 8U/1T/10U/1T/10U/1T/4U/1T/4U | 40 |
| Example IX | 8U/1T/10U/1T/10U/1T/4U/1T/4U | 31 |
| Comparative | 36U | 42 |
| Exp. A | | |

The results indicate that packages according to the invention have substantially lower average BFD than the package according to the state of the art.

The multilayered material sheet and antiballistic article of the present invention are particularly advantageous over previously known antiballistic materials as they provide an improved level of protection especially in the form of back face deformation as the known articles at a low weight.

1. Multilayered material sheet comprising a stack of fibrous layers, and one or more substacks of trauma reducing layers comprising a non woven network of randomly oriented reinforcing fibers, a polymeric foam or a polymeric film, wherein at least one of the substacks is positioned within the stack.

2. Material sheet according to claim 1, wherein the stack comprises at least four substacks, separated by at least one fibrous layer.

3. Material sheet according to claim 1, wherein each substack comprises at most four trauma reducing layers.

4. Material sheet according to claim, wherein each substack comprises only one trauma reducing layer.

5. Material sheet according to claim 1, wherein at least 50% of the total areal weight of the trauma reducing layers is positioned in that half part of the stack facing the strike face.

6. Material sheet according to claim 1, wherein at least 75% of the total areal weight of the trauma reducing layers is positioned in that half part of the stack facing the strike face.

7. Material sheet according to claim 1, wherein the fibrous layers comprise networks selected from the group consisting of a woven network of reinforcing fibers, a knitted network of reinforcing fibers, a braided network of reinforcing fibers, and a nonwoven network of oriented reinforcing fibers.

8. Material sheet according to claim 7, wherein the nonwoven network of oriented reinforcing fibers in the fibrous layers comprises a plurality of unidirectional monolayers.

9. Material sheet according to claim 8, wherein the reinforcing fibers in one monolayer are oriented at an angle with respect to the reinforcing fibers in an adjacent monolayer.

10. Material sheet according to claim 1, wherein the network comprises woven tapes.

11. Material sheet according to claim 1, wherein the nonwoven networks of randomly oriented reinforcing fibers comprise discontinuous fibers.

12. Material sheet according to claim 1, wherein the nonwoven networks of randomly oriented reinforcing fibers is a felt.

13. Ballistic resistant vest comprising the multilayered material sheet according to claim 1.

14. The use of a material sheet according to claim 1 in the manufacture of a soft antiballistic article.
